(19) United States
(12) Patent Application Publication
(10) Pub. No.: US 2012/0196044 A1
(43) Pub. Date: Aug. 2, 2012

(54) METHOD FOR PRODUCING HEAT-TREATED LIQUID CRYSTAL POLYESTER-IMPREGNATED BASE MATERIAL

(75) Inventor: Shohei AZAMI, Tsukuba-shi (JP)

(73) Assignee: SUMITOMO CHEMICAL COMPANY, LIMITED, Tokyo (JP)

(21) Appl. No.: 13/357,153

(22) Filed: Jan. 24, 2012

(30) Foreign Application Priority Data
Jan. 28, 2011 (JP) 2011-016448

(51) Int. Cl. B05D 3/02

(52) U.S. Cl. 427/389.8; 427/444

(57) ABSTRACT

An object of the present invention is to provide a method for producing a heat-treated liquid crystal polyester-impregnated base material, in which the portion to be practically used as the liquid crystal polyester-impregnated base material after a heat treatment is not welded to the supporting member. In the step of heat-treating a first liquid crystal polyester-impregnated base material, the first liquid crystal polyester-impregnated base material is heat-treated while supporting by a supporting member in the site other than the portion to be practically used after the heat treatment to obtain a second liquid crystal polyester-impregnated base material.

### BACKGROUND OF THE INVENTION

(1) Field of the Invention

The present invention relates to a method for producing a heat-treated liquid crystal polyester-impregnated base material.

(2) Description of Related Art

A liquid crystal polyester-impregnated base material can be produced, for example, by impregnating a base material such as a glass cloth with a liquid crystal polyester solution, and then removing a solvent. Such a liquid crystal polyester-impregnated base material has hitherto been examined as the material of an insulating layer of a printed circuit board (printed board, printed circuit board) to be assembled into various electronic instruments since it has high heat resistance and strength and also has excellent dimensional stability and low dielectric loss (see, for example, International Publication No. WO2008/143455). When the liquid crystal polyester-impregnated base material is used as the material of the insulating layer, it is ordinary that the liquid crystal polyester-impregnated base material is subjected to a heat treatment in advance thereby increasing the molecular weight, and then hot-pressed thereby laminating together with a metal foil.

However, there was a problem that when the liquid crystal polyester-impregnated base material is directly arranged on a supporting material such as a tray made of metal, the portion to be practically used as the liquid crystal polyester-impregnated base material is welded to the supporting material by a heat treatment.

### SUMMARY OF THE INVENTION

Under these circumstances, the present invention has been made and an object thereof is to provide a method for producing a heat-treated liquid crystal polyester-impregnated base material, in which the portion to be practically used as the liquid crystal polyester-impregnated base material after a heat treatment is not welded to the supporting material.

In order to solve the problem, the present invention provides a method for producing a heat-treated liquid crystal polyester-impregnated base material, which comprises the step of heat-treating a liquid crystal polyester-impregnated base material, wherein the liquid crystal polyester-impregnated base material is heat-treated while supporting by a supporting member in the site other than the portion to be practically used after the heat treatment in the step.

In the method for producing a heat-treated liquid crystal polyester-impregnated base material according to the present invention, it is preferred that the contact area of the base material with the supporting member accounts for 15% or less in the surface supported by the supporting member of the liquid crystal polyester-impregnated base material.

In the method for producing a heat-treated liquid crystal polyester-impregnated base material according to the present invention, it is preferred that the supporting member is made of a resin, metal, alloy or ceramic and has a frame shape, and the liquid crystal polyester-impregnated base material is supported by applying the peripheral portion of the liquid crystal polyester-impregnated base material to the supporting member.

In the method for producing a heat-treated liquid crystal polyester-impregnated base material according to the present invention, it is preferred that the supporting member is a clip made of a metal or alloy and is bonded to the other end of a connecting member made of a metal or alloy having fixed one end, and the liquid crystal polyester-impregnated base material is supported by interposing the liquid crystal polyester-impregnated base material between the supporting member.

In the method for producing a heat-treated liquid crystal polyester-impregnated base material according to the present invention, it is preferred that the liquid crystal polyester includes repeating units represented by the following formulas (1), (2) and (3):

—O—Ar¹—CO—, (1)

—Co—Ar²—CO—, and (2)

—X—Ar³—Y— (3)

wherein Ar¹ represents a phenylene group, a naphthylene group or a biphenylylene group; Ar² and Ar³ each independently represents a phenylene group, a naphthylene group, a biphenylylene group or a group represented by the following formula (4); X and Y each independently represents an oxygen atom or an imino group; and one or more hydrogen atoms existing in Ar¹, Ar² or Ar³ each independently may be substituted with a halogen atom, an alkyl group or an aryl group, and

—Ar⁴—Z—Ar⁵— (4)

wherein Ar⁴ and Ar⁵ each independently represents a phenylene group or a naphthylene group; and Z represents an oxygen atom, a sulfur atom, a carbonyl group, a sulfonyl group or an alkylidene group.

In the method for producing a heat-treated liquid crystal polyester-impregnated base material according to the present invention, it is preferred that the liquid crystal polyester includes 30 to 80 mol % of a repeating unit represented by the formula (1), 10 to 35 mol % of a repeating unit represented by the formula (2) and 10 to 35 mol % of a repeating unit represented by the formula (3), based on the total amount of all repeating units constituting the liquid crystal polyester.

In the method for producing a heat-treated liquid crystal polyester-impregnated base material according to the present invention, it is preferred that X and/or Y is/are imino group(s) in the general formula (3).

In the method for producing a heat-treated liquid crystal polyester-impregnated base material according to the present invention, the liquid crystal polyester includes a repeating unit derived from p-hydroxybenzoic acid and a repeating unit derived from 2-hydroxy-6-naphthoic acid in the total content of 30.0 to 45.0 mol %, repeating units derived from one or more compounds selected from the group consisting of terephthalic acid, isophthalic acid and 2,6-naphthalenedicarboxylic acid in the total content of 25.0 to 35.0 mol %, and a repeating unit derived from 4-aminophenol in the total content of 25.0 to 35.0 mol %, based on the total amount of all repeating units constituting the liquid crystal polyester.

In the method for producing a heat-treated liquid crystal polyester-impregnated base material according to the present invention, it is preferred that the liquid crystal polyester-impregnated base material is obtained by impregnating a glass cloth with a liquid crystal polyester.

According to the present invention, it is possible to provide a method for producing a heat-treated liquid crystal polyester-impregnated base material, in which the portion to be practically used as the liquid crystal polyester-impregnated base material after a heat treatment is not welded to the supporting material.

### BRIEF DESCRIPTION OF THE DRAWINGS

FIGS. 1A and 1B are schematic views each showing a supporting mode of a liquid crystal polyester-impregnated base material upon a heat treatment in an embodiment of the present invention, in which FIG. 1A is a perspective view and FIG. 1B is a plan view seen from the opposite side to a supporting direction; and

FIG. 2 is a schematic view showing another supporting mode of a liquid crystal polyester-impregnated base material upon a heat treatment in an embodiment of the present invention.

### DETAILED DESCRIPTION OF PREFERRED EMBODIMENTS

The present invention will be described in detail below.

The method for producing a heat-treated liquid crystal polyester-impregnated base material of the present invention (hereinafter referred to as a “second liquid crystal polyester-impregnated base material”) is characterized by including the step of heat-treating a liquid crystal polyester-impregnated base material (hereinafter referred to as a “first liquid crystal polyester-impregnated base material”), wherein the first liquid crystal polyester-impregnated base material is heat-treated while supporting by a supporting member in the site other than the portion to be practically used after the heat treatment in the step.

The second liquid crystal polyester-impregnated base material is obtained by increasing the molecular weight of a liquid crystal polyester in the first liquid crystal polyester-impregnated base material as a result of the heat treatment.

There is no particular limitation on the supporting material as long as it can stably support the first liquid crystal polyester-impregnated base material upon a heat treatment.

The material of the supporting material may be any material having heat resistance, and examples thereof include metals such as aluminum; alloys such as stainless steel (SUS); ceramics such as alumina; and resins such as aramid, polyetherimide, polyimide, liquid crystal polymer and polytetrafluoroethylene. The resins are preferably resins which exhibit a melting point of 320° C. or higher as measured by differential scanning calorimetry, or they do not undergo decomposition at lower than 320° C. and also do not exhibit a melting point. This is because the heating temperature upon the heat treatment is often set at lower than 320° C. The term “does not exhibit a melting point” mainly means that it is decomposed.

There is no particular limitation on the shape of the supporting member as long as it has a supporting portion of the first liquid crystal polyester-impregnated base material and may be, for example, a supporting member having only a site capable of mounting the first liquid crystal polyester-impregnated base material, such as a pin-, block- or frame-shaped supporting members ((i)), or may be a supporting member having a site capable of interposing the first liquid crystal polyester-impregnated base material, such as a clip-shaped supporting member ((ii)). Such a supporting member can be produced by molding or processing using a known method according to the material.

For example, the material of the supporting member (i) is preferably any of resins, metals, alloys and ceramics. The material of the supporting member (ii) is preferably metals or alloys.

The number of supporting members used may be selected by taking the shape of the supporting member into consideration, and may be one, or two or more.

When the number of supporting members used is two or more, one kind of a supporting member may be used, or two or more kinds of supporting members may be used. When two or more kinds of supporting members are used, the combination and ratio may be appropriately selected according to the purposes.

The contact portion of the first liquid crystal polyester-impregnated base material with the supporting member may preferably account for 15% or less of the area in the surface supported by the supporting member of the first liquid crystal polyester-impregnated base material. Whereby, the first liquid crystal polyester-impregnated base material can be stably supported by the supporting member, and also the portion to be practically used after the heat treatment can be widely secured.

For example, when the first liquid crystal polyester-impregnated base material is interposed using a clip-shaped supporting member or the like, in case the contact portion with the supporting member exists on both surfaces, i.e. front and back surfaces of the first liquid crystal polyester-impregnated base material, the contact portion preferably accounts for 15% or less of the area on the surface having a larger contact portion with the supporting member.

The first liquid crystal polyester-impregnated base material can be produced, for example, by impregnating a base material with a liquid composition containing a liquid crystal polyester and a solvent, and then removing a solvent from the obtained composition-impregnated base material.

The liquid crystal polyester is a liquid crystal polyester which exhibits mesomorphism in a molten state, and is preferably melted at a temperature of 450° C. or lower. The liquid crystal polyester may be a liquid crystal polyester amide, a liquid crystal polyester ether, a liquid crystal polyester carbonate, or a liquid crystal polyester imide. The liquid crystal polyester is preferably a wholly aromatic liquid crystal polyester obtained by using only an aromatic compound as a raw monomer.

Typical examples of the liquid crystal polyester include:

(I) those obtained by polymerization (polycondensation) of an aromatic hydroxycarboxylic acid, an aromatic dicarboxylic acid, and at least one kind of compound selected from the group consisting of an aromatic diol, an aromatic hydroxyamine and an aromatic diamine;

(II) those obtained by polymerization of plural kinds of aromatic hydroxycarboxylic acids;

(III) those obtained by polymerization of an aromatic dicarboxylic acid, and at least one kind of compound selected from the group consisting of an aromatic diol, an aromatic hydroxyamine and an aromatic diamine; and

(IV) those obtained by polymerization of a polyester such as polyethylene terephthalate, and an aromatic hydroxycarboxylic acid. Herein, there each independently may be used a polymerizable derivative thereof in place of a part or all of the aromatic hydroxycarboxylic acid, aromatic dicarboxylic acid, aromatic diol, aromatic hydroxyamine and aromatic diamine.

Examples of the polymerizable derivative of the compound having a carboxyl group such as an aromatic hydroxycarboxylic acid or aromatic dicarboxylic acid include those obtained by converting a carboxyl group into an alkoxycarbonyl group or an aryloxycarbonyl group (ester); those obtained by converting a carboxyl group into a haloformyl group (acid halide); and those obtained by converting a carboxyl group into an acyloxycarbonyl group (acid anhydride).

Examples of the polymerizable derivative of the compound having a hydroxyl group such as an aromatic hydroxycarboxylic acid, an aromatic diol or an aromatic hydroxyamine include those obtained by converting a hydroxyl group into an acyloxyl group through acylation (acylated product).

Examples of the polymerizable derivative of the compound having an amino group such as an aromatic hydroxyamine or an aromatic diamine include those obtained by converting an amino group into an acylamino group through acylation (acylated product).

The liquid crystal polyester preferably includes a repeating unit represented by the following formula (1) (hereinafter may be sometimes referred to a “repeating unit (1)”), and more preferably includes the repeating unit (1), a repeating unit represented by the following formula (2) (hereinafter may be sometimes referred to a “repeating unit (2)”) and a repeating unit represent by the following formula (3) (hereinafter may be sometimes referred to a “repeating unit (3)”):

—O—Ar¹—CO—, (1)

—CO—Ar²—CO—, and (2)

—X—Ar³—Y— (3)

wherein Ar¹ represents a phenylene group, a naphthylene group or a biphenylylene group; Ar² and Ar³ each independently represents a phenylene group, a naphthylene group, a biphenylylene group or a group represented by the following formula (4); X and Y each independently represents an oxygen atom or an imino group; and one or more hydrogen atoms existing in Ar¹, Ar² or Ar³ each independently may be substituted with a halogen atom, an alkyl group or an aryl group, and

—Ar⁴—Z—Ar⁵— (4)

wherein Ar⁴ and Ar⁵ each independently represents a phenylene group or a naphthylene group; and Z represents an oxygen atom, a sulfur atom, a carbonyl group, a sulfonyl group or an alkylidene group.

Examples of the halogen atom include a fluorine atom, a chlorine atom, a bromine atom and an iodine atom.

Examples of the alkyl group include a methyl group, an ethyl group, an n-propyl group, an isopropyl group, an n-butyl group, an isobutyl group, an s-butyl group, a t-butyl group, an n-pentyl group, an n-hexyl group, an n-heptyl group, a 2-ethylhexyl group, an n-octyl group, an n-nonyl group and an n-decyl group, and the number of carbon atoms is preferably from 1 to 10.

Examples of the aryl group include a phenyl group, an o-tolyl group, an m-tolyl group, a p-tolyl group, a 1-naphthyl group and a 2-naphthyl group, and the number of carbon atoms is preferably from 6 to 20.

When the hydrogen atom is substituted with these groups, the number thereof is independently preferably 2 or less, and more preferably 1 or less, respectively, every group represented by Ar¹, Ar² or Ar³.

Examples of the alkylidene group include a methylene group, an ethylidene group, an isopropylidene group, an n-butylidene group and a 2-ethylhexylidene group, and the number of carbon atoms is preferably from 1 to 10.

The repeating unit (1) is a repeating unit derived from a predetermined aromatic hydroxycarboxylic acid. The repeating unit (1) is preferably a repeating unit in which Ar¹ is a p-phenylene group (a repeating unit derived from a p-hydroxybenzoic acid), or a repeating unit in which Ar¹ is a 2,6-naphthylene group (a repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar² is a p-phenylene group (a repeating unit derived from terephthalic acid), a repeating unit in which Ar² is a m-phenylene group (a repeating unit derived from isophthalic acid), a repeating unit in which Ar² is a 2,6-naphthylene group (a repeating unit derived from 2,6-naphthalenedicarboxylic acid), or a repeating unit in which Ar² is a diphenylether-4,4′-diyl group (a repeating unit derived from diphenylether-4,4′-dicarboxylic acid).

The repeating unit (3) is a repeating unit derived from a predetermined aromatic diol, an aromatic hydroxylamine or an aromatic diamine. The repeating unit (3) is preferably a repeating unit in which Ar³ is a p-phenylene group (a repeating unit derived from hydroquinone, p-aminophenol or p-phenylenediamine), or a repeating unit in which Ar³ is a 4,4′-biphenylylene group (a repeating unit derived from 4,4′-dihydroxybiphenyl, 4-amino-4′-hydroxybiphenyl or 4,4′-diaminobiphenyl).

The content of the repeating unit (1) is preferably 30 mol % or more, more preferably 30 to 80 mol %, still more preferably from 30 to 60 mol %, and particularly preferably from 30 to 40 mol %, based on the total amount of all repeating units constituting a liquid crystal polyester (value in which the mass of each repeating unit constituting a liquid crystal polyester is divided by a formula weight of each repeating unit thereof to determine the amount (mol) corresponding to the amount of a substance of each repeating unit, and then the obtained amounts are totaled).

The content of the repeating unit (2) is preferably 35 mol % or less, more preferably from 10 to 35 mol %, still more preferably from 20 to 35 mol %, and particularly preferably from 30 to 35 mol %, based on the total amount of all repeating units constituting a liquid crystal polyester.

The content of the repeating unit (3) is preferably 35 mol % or less, more preferably from 10 to 35 mol %, still more preferably from 20 to 35 mol %, and particularly preferably from 30 to 35 mol %, based on the total amount of all repeating units constituting a liquid crystal polyester.

As the content of the repeating unit (1) increases, heat resistance as well as strength and rigidity are likely to be improved. However, when the content is too large, solubility in a solvent is likely to decrease.

A ratio of the content of the repeating unit (2) to the content of the repeating unit (3) is preferably from 0.9/1 to 1/0.9, more preferably from 0.95/1 to 1/0.95, and still more preferably from 0.98/1 to 1/0.98, in terms of [content of the repeating unit (2)]/[content of the repeating unit (3)] (mol/mol).

The liquid crystal polyester may include two or more kinds of each of the repeating units (1) to (3), independently. The liquid crystal polyester may include a repeating unit other than the repeating units (1) to (3), and the content thereof is preferably 10 mol % or less, and more preferably 5 mol % or less, based on the total amount of all repeating units constituting a liquid crystal polyester.

The liquid crystal polyester preferably includes, as the repeating unit (3), a repeating unit in which X and/or Y is/are imino group(s), that is, a repeating unit derived from a predetermined aromatic hydroxylamine and/or a repeating unit derived from aromatic diamine, and more preferably includes, as the repeating unit (3), only a repeating unit in which X and/or Y is/are imino group(s). Whereby, the obtained liquid crystal polyester exhibits more excellent solubility in a solvent.

The liquid crystal polyester preferably includes a repeating unit derived from p-hydroxybenzoic and a repeating unit derived from 2-hydroxy-6-naphthoic acid in the total amount of 30.0 to 45.0 mol % based on the total amount of all repeating units constituting the liquid crystal polyester.

The liquid crystal polyester preferably includes a repeating unit derived from one or more compounds selected from the group consisting of terephthalic acid, isophthalic acid and 2,6-naphthalenedicarboxylic acid in the total amount of 25.0 to 35.0 mol % based on the total amount of all repeating units constituting the liquid crystal polyester.

The liquid crystal polyester preferably includes a repeating unit derived from 4-aminophenol in an amount of 25.0 to 35.0 mol % based on the total amount of all repeating units constituting the liquid crystal polyester. The liquid crystal polyester preferably includes all repeating units in such a ratio.

The liquid crystal polyester is preferably produced by melt-polymerizing a raw monomer corresponding to a repeating unit constituting the liquid crystal polyester, and subjecting the obtained polymer (prepolymer) to solid phase polymerization. Whereby, it is possible to produce a high-molecular weight liquid crystal polyester having excellent heat resistance as well as high strength and rigidity with satisfactory operability. The melt polymerization may be carried out in the presence of a catalyst, and examples of the catalyst include metal compounds such as magnesium acetate, stannous acetate, tetrabutyl titanate, lead acetate, sodium acetate, potassium acetate and antimony trioxide; and nitrogen-containing heterocylic compounds such as 4-(dimethylamino)pyridine and 1-methylimidazol. Among these catalysts, nitrogen-containing heterocylic compounds are preferably used.

The flow initiation temperature of the liquid crystal polyester is preferably 250° C. or more, more preferably from 250 to 350° C., and still more preferably from 260 to 330° C. As the flow initiation temperature increases, heat resistance as well as strength and rigidity are likely to be improved. However, when the flow initiation temperature is too high, solubility in the solvent is likely to decrease and the viscosity of the liquid composition is likely to increase.

The flow initiation temperature is also called a flow temperature and means a temperature at which a melt viscosity becomes 4,800 Pa·s (48,000 poise) when a liquid crystal polyester is melted while heating at a heating rate of 4° C./min under a load of 9.8 MPa (100 kg/cm²) and extruded through a nozzle having an inner diameter of 1 mm and a length of 10 mm using a capillary rheometer, and the flow initiation temperature serves as an index indicating a molecular weight of the liquid crystal polyester (see “Liquid Crystalline Polymer-Synthesis, Molding, and Application” edited by Naoyuki Koide, page 95, published by CMC Publishing CO., LTD., issued on Jun. 5, 1987).

The liquid composition contains a liquid crystal polyester and a solvent. The solvent is appropriately selected from those which can dissolve the liquid crystal polyester used, specifically a solvent which can dissolve in the concentration ([liquid crystal polyester]/[liquid crystal polyester+solvent]×100) of 1% by mass or more at 50° C.

Examples of the solvent include halogenated hydrocarbons such as dichloromethane, chloroform, 1,2-dichloroethane, 1,1,2,2,-tetrachloroethane and o-dichlorobenzene; phenol halides such as p-chlorophenol, pentachlorophenol and pentafluorophenol; ethers such as diethylether, tetrahydrofuran and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amide-based compounds (compounds having an amide bond) such as N,N-dimethylformamide, N,N-dimethylacetamide and N-methyl pyrrolidone, urea compounds such as tetramethylurea; nitro compounds such as nitromethane and nitrobenzene; sulfur compounds such as dimethyl sulfoxide and sulfolane; and phosphorus compounds such as hexamethylphosphoric acid amide and tri-n-butylphosphoric acid. Two or more kinds of these solvents may be used.

The solvent is preferably a solvent containing, as a main component, an aprotic compound, and particularly an aprotic compound having no halogen atom, since the solvent is easily handled because of low corrosion resistance. The content of the aprotic compound in the entire solvent is preferably from 50 to 100% by mass, more preferably from 70 to 100% by mass, and still more preferably from 90 to 100% by mass.

It is preferred to use, as the aprotic compound, amide-based compounds such as N,N-dimethylformamide, N,N-dimethylacetamide and N-methyl pyrrolidone since it is easy to dissolve the liquid crystal polyester.

The solvent is preferably a solvent containing, as a main component, a compound having a dipole moment of 3 to 5 since it is easy to dissolve the liquid crystal polyester. The content in the entire solvent of the compound having a dipole moment of 3 to 5 is preferably 50 to 100% by weight, more preferably from 70 to 100% by weight, and still more preferably from 90 to 100% by weight. It is preferred to use, as the aprotic compound, a compound having a dipole moment of 3 to 5.

The solvent is preferably a solvent containing, as a main component, a compound having a boiling point at 1 atm of 220° C. or lower since it is easy to remove. The content in the entire solvent of the compound having a boiling point at 1 atm of 220° C. or lower is preferably from 50 to 100% by weight, more preferably from 70 to 100% by weight, and still more preferably from 90 to 100% by weight. It is preferred to use, as the aprotic compound, a compound having a boiling point at 1 atm of 220° C. or lower.

The content of the liquid crystal polyester in the liquid composition is usually from 5 to 60% by mass, preferably from 10 to 50% by mass, and more preferably from 15 to 45% by mass, based on the total amount of the liquid crystal polyester and solvent, and the content is appropriately adjusted so as to obtain a liquid composition having a desired viscosity.

The liquid composition may contain one or more kinds of other components such as a filler, an additive, and a resin other than the liquid crystal polyester.

Examples of the filler include inorganic fillers such as silica, alumina, titanium oxide, barium titanate, strontium titanate, aluminum hydroxide and calcium carbonate; and organic fillers such as a hardened epoxy resin, a crosslinked benzoguanamine resin and a crosslinked acrylic resin. The content of the filler is preferably from 0 to 100 parts by mass based on 100 parts by mass of the liquid crystal polyester.

Examples of the additive include a leveling agent, a defoamer, an antioxidant, an ultraviolet absorber, a flame retardant and a coloring agent. The content thereof is preferably from 0 to 5 parts by mass based on 100 parts by mass of the liquid crystal polyester.

Examples of the resin other than the liquid crystal polyester include thermoplastic resins such as polypropylene, polyamide, polyester other than the liquid crystal polyester, polyphenylene sulfide, polyetherketone, polycarbonate, polyethersulfone, polyphenyleneether and polyetherimide; and thermosetting resins such as a phenol resin, an epoxy resin, a polyimide resin and a cyanate resin. The content thereof is preferably from 0 to 20 parts by mass based on 100 parts by mass of the liquid crystal polyester.

The liquid composition can be prepared by mixing a liquid crystal polyester, a solvent, and other components to be optionally used, collectively or in a suitable order. When the filler is used as other components, the liquid composition is preferably prepared by dissolving the liquid crystal polyester in the solvent to obtain a liquid crystal polyester solution, and then dispersing a filler in this liquid crystal polyester solution.

The material of the base material to be impregnated with the liquid crystal polyester may be any one of an inorganic fiber and an organic fiber, and is preferably in a sheet form.

The base material made of the inorganic fiber is preferably a sheet made mainly of a glass fiber, that is, a glass cloth.

The base material made of the organic fiber is preferably a sheet made of polybenzoxide, aramid, liquid crystal polymer and the like.

The glass cloth is preferably made of an alkali-containing glass fiber, a non-alkali glass fiber or a low dielectric glass fiber. The fiber constituting the glass cloth may be partially mixed with a ceramic fiber made of ceramics other than glass, or a carbon fiber. The fiber constituting the glass cloth may be surface-treated with a coupling agent such as an aminosilane-based coupling agent, an epoxysilane-based coupling agent or a titanate-based coupling agent.

Examples of the method for producing a glass cloth made of these fibers include a method in which a fiber constituting a glass cloth is dispersed in water and a sizing agent such as an acrylic resin is optionally added, and sheet making using a paper machine and then drying to obtain a nonwoven fabric, and a method in which a known weaving machine is used.

It is possible to use, as a technique of weaving a fiber, a plain weaving, satin weaving, twill weaving and mat weaving techniques. The weaving density is preferably 10 to 100 fibers/25 mm.

The mass per unit area of the glass cloth is preferably from 10 to 300 g/m².

The thickness of the glass cloth is preferably from 10 to 200 μm, and more preferably from 10 to 180 μm.

The glass cloth may be a commercially available product. Examples of the glass cloth as a commercially available product which is easily available include those for an insulating impregnated base material of electronic components and are available from Asahi-SCHWEBEL Co., LTD., Nitto Boseki Co., Ltd., Arisawa Manufacturing Co., Ltd. and the like.

Examples of the commercially available glass cloth with a suitable thickness include those with IPC names of 1035, 1078, 2116 and 7628.

Examples of the method of impregnating the base material with the liquid composition include a method in which the base material is immersed in the liquid composition in an immersion tank. In this method, it is possible to easily control the amount of a liquid crystal polyester, with which the base material is impregnated, by appropriately adjusting the content of the crystal polyester of the liquid composition, the immersion time, and the rate of taking up of the immersed base material from the liquid composition.

There is no particular limitation on the method of removing the solvent from the composition-impregnated base material, and the method is preferably a method of vaporization of the solvent from the viewpoint of a simple operation. Examples of the method include a method in which vaporization is carried out by using any one of heating, depression and ventilation alone, or using two or more kinds of them in combination.

The step of heat-treating a first liquid crystal polyester-impregnated base material is preferably carried out under an atmosphere of an inert gas such as nitrogen. The heating temperature upon a heat treatment is lower than 320° C., and preferably from 240 to 310° C., and the heating time is preferably from 1 to 30 hours. From the viewpoint of obtaining a second liquid crystal polyester-impregnated base material having more satisfactory heat resistance, the heating temperature is preferably 250° C. or higher, and more preferably from 260 to 310° C. From the viewpoint of an improvement in productivity, the heating time is preferably from 1 to 10 hours.

After carrying out the heat treatment step, the treated product is peeled off from the supporting member and the portion which was at least the contact site with the supporting member is removed, and the remaining portion may be allowed to serve as the portion to be practically used of the second liquid crystal polyester-impregnated base material.

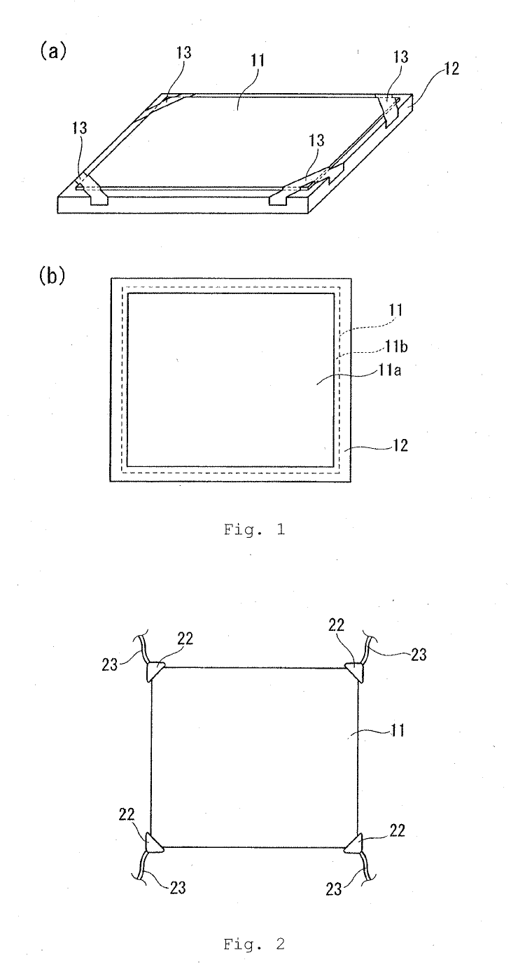

FIGS. 1A and 1B are schematic views each showing a supporting mode of a first liquid crystal polyester-impregnated base material in an embodiment of the present invention, in which FIG. 1A is a perspective view and FIG. 1B is a plan view seen from the opposite side (supporting member side) to a supporting direction.

The supporting mode shown herein is a specific example when the above (i) is used as the supporting member. More specifically, the supporting member is as follows.

The supporting member 12 has a frame shape and a peripheral portion of the first liquid crystal polyester-impregnated base material 11 to be heat-treated is mounted thereon, and also the first liquid crystal polyester-impregnated base material 11 is fixed and supported to a supporting member 12 at four corners using a heat-resistant adhesive tape 13. Regarding the first liquid crystal polyester-impregnated base material 11, in the surface opposite the supporting member 12 (supporting surface supported by a supporting member 12), the portion corresponding to the site from which the contact site 11b with the supporting member 12 is removed (non-contact site 11a) can serve as the portion to be practically used of the second liquid crystal polyester-impregnated base material. In the supporting surface by the supporting member 12, the contact site 11b preferably accounts for 15% or less of the area (the non-contact site 11a accounts for 85% or more of the area).

The first liquid crystal polyester-impregnated base material 11 is preferably supported without bending on the supporting member 12. Whereby, the obtained second liquid crystal polyester-impregnated base material is also without bending and thus handling properties are improved.

The first liquid crystal polyester-impregnated base material 11 supported on the supporting member 12 may be horizontally arranged so that the supporting surface is directed in a vertical direction (an upward or downward direction) upon a heat treatment, or may be vertically arranged so that the supporting surface is directed in a horizontal direction (a lateral direction), or may be arranged so that the supporting surface is directed in an oblique direction (neither vertical nor horizontal direction).

FIG. 1 shows an example in which a first liquid crystal polyester-impregnated base material 11 is fixed to a supporting member 12 using a heat-resistant adhesive tape 13. However, still another supporting member 12 may be arranged on the peripheral portion of the first liquid crystal polyester-impregnated base material 11 on the opposite side (upper side in FIG. 1A) of the supporting surface of the first liquid crystal polyester-impregnated base material 11 without using the heat-resistant adhesive tape 13, thereby interposing the first liquid crystal polyester-impregnated base material 11. As shown in FIG. 1A, when the supporting surface of the first liquid crystal polyester-impregnated base material 11 is directed to the downward direction, the first liquid crystal polyester-impregnated base material 11 may not be fixed to the supporting member 12.

The contact site of the first liquid crystal polyester-impregnated base material with the supporting member is not necessarily the peripheral portion. However, the peripheral portion is preferable since it is possible to ensure the portion to be practically used.

FIG. 2 is a schematic view showing another supporting mode of a first liquid crystal polyester-impregnated base material in an embodiment of the present invention.

The supporting mode shown herein is a specific example when the above (ii) is used as the supporting member. More specifically, the supporting member is as follows.

The supporting member 22 has a clip shape, and the first liquid crystal polyester-impregnated base material 11 to be heat-treated is mounted thereon, and also the first liquid crystal polyester-impregnated base material 11 to be heat-treated, bonded to the other end of a connecting member 23 having a fixed one end, is fixed and supported at four corners by four supporting members 22. The connecting member 23 may be the same material as that of the supporting member 22. However, metals or alloys are preferable since strain upon a heat treatment can be more suppressed. From the viewpoint of handling properties, the connecting member 23 preferably has a string or chain shape. For example, one end of the connecting member 23 is preferably fixed to the interior of a heat treatment device such as a heater.

Regarding the first liquid crystal polyester-impregnated base material 11, a non-contact site with the supporting member 22 can serve as the portion to be practically used of the second liquid crystal polyester-impregnated base material. Therefore, it is advantageous as compared with the supporting mode shown in FIG. 1 since it is possible to ensure the portion to be practically used, easily and widely. In FIG. 2, the contact site of the first liquid crystal polyester-impregnated base material 11 with the supporting member 22 exists on both surfaces, i.e. front and back surfaces of the first liquid crystal polyester-impregnated base material, and the contact site preferably accounts for 15% or less of the area (the non-contact site with the supporting member 22 accounts for 85% or more of the area) in the surface having a larger contact area with the supporting member 22.

Similar to the case of FIG. 1, the first liquid crystal polyester-impregnated base material 11 is preferably supported without bending. Whereby, the obtained second liquid crystal polyester-impregnated base material is also without bending and thus handling properties are improved.

Similar to the case of FIG. 1, the first liquid crystal polyester-impregnated base material 11 supported on the supporting member 22 may be horizontally arranged so that the supporting surface is directed in a vertical direction (an upward or downward direction) upon a heat treatment, or may be vertically arranged so that the supporting surface is directed in a horizontal direction (a lateral direction), or may be arranged so that the supporting surface is directed in an oblique direction (neither vertical nor horizontal direction).

FIG. 2 shows the case where contact sites of the first liquid crystal polyester-impregnated base material 11 with,the supporting member 22 are four corners. However, the contact sites may be the peripheral portions other than four corners. The drawing also shows the case where the number of supporting members 22, which support the first liquid crystal polyester-impregnated base material 11, is four. However, the number may be one, or plural other than four. In order to stably support the first liquid crystal polyester-impregnated base material 11, the number is preferably four or more.

The arrangement forms shown in FIGS. 1 to 2 are suited to carry out a heat treatment of the first liquid crystal polyester-impregnated base material in a “batchwise manner”. In this case, for example, plural first liquid crystal polyester-impregnated base materials supported by the supporting member are preferably arranged at intervals with each other in a heat treatment device.

In contrast, when the heat treatment of the first liquid crystal polyester-impregnated base material is carried out in a “continuous manner”, the following method is employed. For example, using, as a conveying roll, those provided with a protrusion corresponding on the conveying surface in a device in which a long first liquid crystal polyester-impregnated base material is delivered from a delivery roll and is taken up by a take-up roll through the conveying roll on the way, a heat treatment is carried out so that the first liquid crystal polyester-impregnated base material is contacted only with the protrusion of the conveying roll. In such a case, the number of conveying rolls can be optionally selected according to the purposes.

According to the present invention, since the non-contact site with the supporting member is allowed to serve as the portion to be practically used of the second liquid crystal polyester-impregnated base material, the second liquid crystal polyester-impregnated base material is scarcely welded to the entire (supporting material) which supports the second liquid crystal polyester-impregnated base material, such as a supporting member, and thus appearance does not deteriorate. For example, surface roughening caused by peeling from the supporting material to which the base material is welded, and transfer of a surface pattern of the supporting material are suppressed.

### EXAMPLES

The present invention will be described in further detail below by way of specific Examples. However, the present invention is not limited to the following Examples.

### <Production of First Liquid Crystal Polyester-Impregnated Base Material>

### Production Example 1

### (1) Production of Liquid Crystal Polyester

In a reactor equipped with a stirrer, a torque meter, a nitrogen gas introducing tube, a thermometer and a reflux condenser, 1,976 g (10.5 mol) of 2-hydroxy-6-naphthoic acid, 1,474 g (9.75 mol) of 4-hydroxyacetoanilide, 1,620 g (9.75 mol) of isophthalic acid and 2,374 g (23.25 mol) of acetic anhydride were charged. After sufficiently replacing the gas in the reactor by a nitrogen gas, the temperature was raised to 150° C. over 15 minutes under a nitrogen gas flow and the mixture was refluxed while maintaining the same temperature (150° C.) for 3 hours.

Then, while distilled off by-produced acetic acid and the unreacted acetic anhydride, the temperature was raised to 300° C. over 170 minutes. At the time when an increase in torque is recognized was regarded as completion of the reaction, and contents were taken out. The contents were cooled to room temperature and crushed by a crusher to obtain a liquid crystal polyester powder having comparatively low molecular weight. With respect to the thus obtained powder, the flow initiation temperature was measured by Flow Tester “Model CFT-500” (manufactured by Shimadzu Corporation). As a result, it was 235° C. Solid phase polymerization was carried out by heat-treating the liquid crystal polyester powder under a nitrogen atmosphere at 223° C. for 3 hours. After the solid phase polymerization, the liquid crystal polyester showed a flow initiation temperature of 270° C.

### (2) Production of First Liquid Crystal Polyester-Impregnated Base Material

The obtained liquid crystal polyester (2,200 g) was added to N,N-dimethylacetamide (DMAc) (7,800 g), followed by heating at 100° C. for 2 hours to obtain a liquid composition. This liquid composition showed a solution viscosity of 320 cP. This melt viscosity is the value obtained by measuring at a measuring temperature of 23° C., using B type viscometer “Model TVL-20” (rotor No. 21, a rotational speed of 5 rpm, manufactured by Toki Sangyo Co., Ltd.).

A glass cloth (thickness of 45 μm, IPC name of 1078, manufactured by Arisawa Manufacturing Co., Ltd.) was impregnated with the thus obtained liquid composition to produce a composition-impregnated base material and the composition-impregnated base material was dried by a hot-air dryer at a set temperature of 160° C. to obtain a first liquid crystal polyester-impregnated base material.

### <Production of Second Liquid Crystal Polyester-Impregnated Base Material>

### Example 1

As shown in FIG. 1, a first liquid crystal polyester-impregnated base material was heat-treated while supporting by a supporting member to produce a second liquid crystal polyester-impregnated base material. Specifically, the production procedure is as follows

A first liquid crystal polyester-impregnated base material was supported to a frame made of SUS (outer frame measuring 29 cm×30 cm, inner frame measuring 26 cm×27 cm) by applying a heat-resistant tape (Product number: No. 973UL-S, fluororesin tape, manufactured by Nitto Denko Corporation) at four positions (four corners of the first liquid crystal polyester-impregnated base material) of the peripheral portion of the first liquid crystal polyester-impregnated base material obtained in Production Example 1 (measuring 28 cm×29 cm). At this time, a contact site with the supporting member accounted for 13.5% of the area in a supporting surface of the first liquid crystal polyester-impregnated base material by the supporting member. In an oven, the first liquid crystal polyester-impregnated base material was arranged in a vertical direction so that the supporting surface is directed in a horizontal direction (a lateral direction) and then heat-treated under a nitrogen gas atmosphere at 290° C. for 3 hours, thereby increasing the molecular weight of a liquid crystal polyester in the first liquid crystal polyester-impregnated base material to produce a second liquid crystal polyester-impregnated base material.

### Example 2

As shown in FIG. 2, a first liquid crystal polyester-impregnated base material was supported by a supporting member and then heat-treated to produce a second liquid crystal polyester-impregnated base material. Specifically, the production procedure is as follows.

The first liquid crystal polyester-impregnated base material obtained in Production Example 1 (measuring 28 cm×29 cm) was supported by interposing four corners (portions measuring 2 cm×2 cm) with a clip made of SUS, thereby bonding this clip to the other end of a wire made of SUS having one end fixed in an oven. At this time, a contact site with the supporting member accounted for 2.0% of the area in a supporting surface of the first liquid crystal polyester-impregnated base material by the supporting member. In an oven, the first liquid crystal polyester-impregnated base material was arranged in a vertical direction so that the supporting surface is directed in a horizontal direction (a lateral direction) and then heat-treated under a nitrogen gas atmosphere at 290° C. for 3 hours, thereby increasing the molecular weight of a liquid crystal polyester in the first liquid crystal polyester-impregnated base material to produce a second liquid crystal polyester-impregnated base material.

### Comparative Example 1

The first liquid crystal polyester-impregnated base material obtained in Production Example 1 was directly placed flat on a bottom surface of this tray made of SUS, facing one surface toward the tray made of SUS (Model number: SUS430). That is, a contact site with the supporting member accounted for 100% of the area in a supporting surface of the first liquid crystal polyester-impregnated base material by the supporting member. In an oven, the first liquid crystal polyester-impregnated base material was heat-treated under a nitrogen gas atmosphere at 290° C. for 3 hours, thereby increasing the molecular weight of a liquid crystal polyester in the first liquid crystal polyester-impregnated base material to produce a second liquid crystal polyester-impregnated base material.

### <Evaluation of Second Liquid Crystal Polyester-Impregnated Base Material>

Appearance of the second liquid crystal polyester-impregnated base material obtained above was visually observed, and then the presence or absence of welding of the second liquid crystal polyester-impregnated base material to a supporting member of the portion to be practically used (a frame, clip or tray made of SUS), and the presence or absence of transfer of a surface pattern from the supporting member were confirmed. The evaluation results are shown in Table 1.

TABLE 1

| | | Contact area of | | |
|---|---|---|---|---|
| | | first liquid poly- | | |
| | | ester-impregnated | Second liquid crystal | |
| | | base material | polyester-impregnated | |
| | Supporting | with supporting | base material | |
| | member | member (%) | Welding | Transfer |
| Example 1 | Frame made of | 13.5 | None | None |
| | SUS | | | |
| Example 2 | Clip made of | 2.0 | None | None |
| | SUS | | | |
| Comparative | Tray made of | 100 | Occurred | Occurred |
| Example 1 | SUS | | | |

As is apparent from the results shown in Table 1, in Examples 1 to 2, regarding the portion to be practically used of the second liquid crystal polyester-impregnated base material, welding to the supporting member was not recognized and also transfer of a surface pattern from the supporting member was not recognized. As described above, according to the present invention, a second liquid crystal polyester-impregnated base material with satisfactory appearance was obtained.

In contrast, in Comparative Example 1, the portion to be practically used of the second liquid crystal polyester-impregnated base material was welded to the supporting member, and thus transfer of a surface pattern from the supporting member was recognized and appearance was poor.

The present invention can be utilized in the production of an insulating layer in a printed circuit board for an electronic instrument.

1. A method for producing a heat-treated liquid crystal polyester-impregnated base material, which comprises the step of heat-treating a liquid crystal polyester-impregnated base material, wherein the liquid crystal polyester-impregnated base material is heat-treated while supporting by a supporting member in the site other than the portion to be practically used after the heat treatment in the step.

2. The method for producing a heat-treated liquid crystal polyester-impregnated base material according to claim 1, wherein the contact area of the base material with the supporting member accounts for 15% or less in the surface supported by the supporting member of the liquid crystal polyester-impregnated base material.

3. The method for producing a heat-treated liquid crystal polyester-impregnated base material according to claim 1, wherein the supporting member is made of a resin, metal, alloy or ceramic and has a frame shape, and the liquid crystal polyester-impregnated base material is supported by applying the peripheral portion of the liquid crystal polyester-impregnated base material to the supporting member.

4. The method for producing a heat-treated liquid crystal polyester-impregnated base material according to claim 1, wherein the supporting member is a clip made of a metal or alloy and is bonded to the other end of a connecting member made of a metal or alloy having fixed one end, and the liquid crystal polyester-impregnated base material is supported by interposing the liquid crystal polyester-impregnated base material between the supporting member.

5. The method for producing a heat-treated liquid crystal polyester-impregnated base material according to claim 1, wherein the liquid crystal polyester includes repeating units represented by the following formulas (1), (2) and (3):
—O—Ar1—CO—, (1)
—CO—Ar2—CO—, and (2)
—X—Ar3—Y— (3)
wherein Ar1 represents a phenylene group, a naphthylene group or a biphenylylene group; Ar2 and Ar3 each independently represents a phenylene group, a naphthylene group, a biphenylylene group or a group represented by the following formula (4); X and Y each independently represents an oxygen atom or an imino group; and one or more hydrogen atoms existing in Ar1, Ar2 or Ar3 each independently may be substituted with a halogen atom, an alkyl group or an aryl group, and
—Ar4—Z—Ar5— (4)
wherein Ar4 and Ar5 each independently represents a phenylene group or a naphthylene group; and Z represents an oxygen atom, a sulfur atom, a carbonyl group, a sulfonyl group or an alkylidene group.

6. The method for producing a heat-treated liquid crystal polyester-impregnated base material according to claim 1, wherein the liquid crystal polyester includes 30 to 80 mol % of a repeating unit represented by the formula (1), 10 to 35 mol % of a repeating unit represented by the formula (2) and 10 to 35 mol % of a repeating unit represented by the formula (3), based on the total amount of all repeating units constituting the liquid crystal polyester.

7. The method for producing a heat-treated liquid crystal polyester-impregnated base material according to claim 1, wherein X and/or Y is/are imino group(s) in the general formula (3).

8. The method for producing a heat-treated liquid crystal polyester-impregnated base material according to claim 1, wherein the liquid crystal polyester includes a repeating unit derived from p-hydroxybenzoic acid and a repeating unit derived from 2-hydroxy-6-naphthoic acid in the total content of 30.0 to 45.0 mol %, repeating units derived from one or more compounds selected from the group consisting of terephthalic acid, isophthalic acid and 2,6-naphthalenedicarboxylic acid in the total content of 25.0 to 35.0 mol %, and a repeating unit derived from 4-aminophenol in the total content of 25.0 to 35.0 mol %, based on the total amount of all repeating units constituting the liquid crystal polyester.

9. The method for producing a heat-treated liquid crystal polyester-impregnated base material according to claim 1, wherein the liquid crystal polyester-impregnated base material is obtained by impregnating a glass cloth with a liquid crystal polyester.
